(19) United States
(12) Patent Application Publication
(10) Pub. No.: US 2003/0236753 A1
(43) Pub. Date: Dec. 25, 2003

(54) Method of safe mediation of payment in connection with network commerce

(76) Inventor: Dag Peter Ljungqvist, Sollentuna (SE)

Correspondence Address: Nixon & Vanderhye, 8th Floor, 1100 North Glebe Road, Arlington, VA, 22201-4714, US

(21) Appl. No.: 10/296,710

(22) PCT Filed: May 28, 2001
(86) PCT No.: PCT/SE01/01179

(30) Foreign Application Priority Data
May 31, 2000 (SE) 0002039-6

(51) Int. Cl. G06F 17/60

(52) U.S. Cl. 705/64

(57) ABSTRACT

The present invention relates to a method for safe mediation of payment via a network in connection with commercial transactions, where a consumer is in contact with a supplier for the purchase of a unit. The invention is based on the assumption that the consumer has an established process of identification with a payment institution. In connection with the purchase, an independent party acts as a mediator, or middleman, in respect of an inquiry from the supplier to the payment institution concerning the possibility of obtaining payment in connection with the purchase. The consumer confirms payment for the purchase in accordance with the established identification process and the payment institution pays the supplier for the purchase in accordance with this confirmation.

### FIELD OF INVENTION

The present invention relates to a method for safe mediation of payment in connection with network commerce, or e-commerce, where a consumer has contact with a supplier for the purchase of a unit, and for transfer of information for customer guidance in the matter of a purchase.

The present invention also relates to a number of computer program products, a carrier medium that carries one or more such computer program products, and a computer readable medium on which one or more such computer program products are stored, which products enable a method according to the present invention to be carried out by execution of the products on a computer.

### DESCRIPTION OF THE BACKGROUND ART

Electronic commerce is an area which is surrounded by high expectations with regard to more rational distribution and improved customer information with respect to prices and other conditions. As will be understood, the wider market afforded by electronic commerce is of great importance to the seller. All in all, electronic commerce is assumed to provide immediate advantages to the buyer, including lower costs per unit and a greater selection.

Buyer and seller seldom know each other in the case of electronic commerce, the norm being that most purchases from respective suppliers are “first time” purchases. The guarantees included with the purchase of the product or service are given by the manufacturer, and consequently all sellers, or tradesmen, are considered by the customer to be just the same.

Various media can be used for commercial transactions, these media ultimately competing with one another. At present, the computer network Internet, cable television and portable telephones are examples of media over which electronic commerce can be carried out.

Combinations of the various systems can also be used. A purchase can be initiated with a transaction via cable television's remote control and terminated via a portable telephone, while another purchase can be initiated over the telephone. Different data program products are suited to different media.

The advances that have been made in encryption, particularly in open-key encryption systems, contribute towards electronic connection (data transfer) between two parties, A and B, that is safe from trespass by a third party, C. A and B can thus feel sure that their conversation will remain private and that C will have no possibility of clearly grasping the conversation, at least not without using significant resources in respect of decryption.

These encryption technologies are also able to verify that the other party is really who he maintains to be. C cannot enter into the role of B and behave as B, without A realising that he is no longer talking to B.

The publication “A Method for Obtaining Digital Signatures and Public-Key Cryptosystems” by R. L. Rivest, A. Shamir and L. Adlerman, published in Communications of the ACM, Vol. 21, No. 2, 1978, pp. 120-126, illustrates and describes an encryption technology according to the above.

However, these technologies are not sufficient to provide buyer and seller is with an environment that is felt to be just as reliable as normal close contact, for instance when buyer and seller meet personally. In other words, it is not sufficient for A to know that he buys from B and that C has no insight into the ongoing sales transactions.

The various technologies that, per se, ensure that one party can be really sure that the other party is really who he maintains to be are, of course, to be preferred when the other party shall be identified, for instance by cable television, Internet supplemented with an encryption system, or portable telephones, which are unique entities in their respective networks. However, there are found identification systems that are based on unsafe connections, for instance the telephone. The unsafe communications link is then supplemented with some other solution so that the whole will be sufficiently safe, for instance one-time codes.

The dominating form of payment over networks, credit cards, cash cards and the like used in different ways, is not a good form of payment. The function of the credit card or pay card etc. is to enable the seller to debit for a delivery at the moment of purchase, and a function of the card has never been intended for use in the way that has now become usual in respect of network commerce.

When a seller has access to the credit card of a buyer, it means that the seller is able to make any debits on the card that he desires. When a transaction is implemented over the counter of a shop, the card owner and the seller are both present at one and the same time, and it is this concurrent presence that guarantees that the transaction is carried out correctly.

In the case of an electronic commerce transaction, the buyer and seller are not present in front of one another, but are situated in different places and united by network communication. Both parties may be convinced per se that the parties are actually who they make out to be and feel secure in the fact that their communication is undisturbed. However, despite the technical systems involved, this method of procedure offers no guarantee that the seller carries out the transaction correctly.

In actual fact, the transaction carried out is highly unsatisfactory.

In the case of a traditional counter transaction, this can be likened to the situation when a customer, in payment of the goods purchased, gives his wallet to the seller, turns his back and asks the seller to take the cash from the wallet, whereafter the seller closes the wallet and returns the closed wallet to the customer, who then takes the goods and leaves the shop and promises the seller not to open his wallet before his monthly bank account is received by post.

No one would think of paying for a typical counter transaction in this way.

Thus, the fundamental fault is in allowing the seller to debit the customer's credit card or the customer's bank account in the case of a cash card or switch card or similar type of card, instead of the buyer handing payment to the seller.

In order for electronic commerce to be made successful globally, it is necessary to create a method of procedure that can be used globally and that satisfies the basic demands that the parties have the right to require of a payment system.

On a small scale and in the physical world, there already exists good prototypes or models that can be used.

For instance, the giro system is frequently used in several European countries. In the case of a giro system, one party, often an organisation independent of bank and payment institutions, takes responsibility for passing on payments between the customers of the system. The giro system is most often liquidity-based, i.e. the system does not include credit functions. The customer is able to order payment to another customer of the giro system with the cash available on his or her account.

A characteristic feature of giro systems is that they are not normally based on the premise that the paying party gives the receiver the possibility of drawing from the sender's account the sum desired by the receiver. Instead, it is the person sending payment who initiates the transfer to the receiver.

The giro system is thus a good model.

However, giro systems are not global and, in practice, vary widely between different parts of the world.

With the introduction of new services of the kind with which the present invention is concerned, it is simple to imagine that the services are based on a completely new technical arrangement. In this case, we can refer to the arrangement as the “payment unit”. This hypothetical “payment unit” should, per se, accommodate all of the functions that interested parties (buyers, sellers, payment institutions) can conceive. In other words, it is a perfect solution.

When examining solutions of this kind that are based on a novel additional arrangement, in our case the “payment unit” it is often found that the original problem of solving payments effectively has been replaced with a new set of problems. How does one spread the “payment unit” globally? How does one achieve utilisation of these “payment units”? How can they be fitted-in both technically and culturally? Will the users be willing to keep them on the desk, in their handbag or in a belt? Will the payment institutions be willing to receive the transactions? Who pays for the payment unit?

A more successful and practicable method of creating new services is, instead, to utilise existing products, systems and services to the greatest possible extent and to supplement and combine these products, systems and services in a novel way to implement novel functions. This avoids the introduction of new “payment units” that would meet with resistance from customers, and will also reduce the necessity of teaching the customers to use new products.

An unavoidable element in payment systems is that customers have faith in the resources used.

The majority of customers and tradesmen have contact with a payment institutions, for instance a bank, and are therefore confident that the payment institutions will handle the customers' money safely. Payment institutions have traditionally been the same as banks, although the role distribution is no longer equally as clear. Grocery retailers offer similar services (through the medium of advanced payment into an account that gives a higher interest than traditional banks); telephone operators also offer similar services through the medium of pay calls, and oil companies take payment on behalf of vehicle parking complexes. In other words, the manner in which payments are made has competition, this competition being intensified with the advent of better, available technologies.

However, functions or parts must be added to the solution in order for it to be usable to all involved. The customer will take a position in respect of making a payment and will not provide details that enable the seller to debit his/her account.

On the other hand, the seller, or retailer, is very anxious to actually receive payment and also requires a common method of communicating with all different payment institutions.

These payment institutions increase their services to also include electronic access to the services offered by the institutions, meaning that the customer is in electronic connection with the payment institutions. The security solutions used differ from institution to institution. However, one characteristic of these institutions is that there is some form of security solution, and that customers and institutions consider it satisfactory that the customer can perform bank services, including sending money to outsiders. Although the solutions are electronic in the majority of cases, manual security solutions, such as one-time codes, may also be used.

The giro model has been complemented with a feature whereby the seller presents to the buyer an invoice in an electronic form, and whereby payment made by the buyer implies that the buyer accepts paying a sum of money that corresponds to the amount invoiced. The seller is thus not able to invoice the buyer's assets directly, but receives payment solely for the goods or the service to be delivered.

In this way, the buyer's risk is restricted to the price of the goods concerned in the purchase and also to the fact that the goods may not live up to expectations. With regard to the risk to the buyer, the nearest comparison that can be made is the same as that relating to a typical post order purchase, which is a considerable improvement to credit card payments.

Another problem that the buyer has is one of obtaining a general view of the available market. It is only when the buyer has a good overall view of the offers made on the market that he/she will benefit from the competition in the greater market.

If a person wishes to buy a particular product, there are a large number of retailers who will be able to offer the product at that particular time. These retailers are unknown to the perspective buyer and, consequently, he/she is unable to arrive at an offer that best suits him/her, without a general view of the market. The large number of retailers does not therefore lead to effective competition.

Different business models have been created for network commerce with the intention of supporting a perspective customer in his desire for a bargain, in one way or another. In its simplest form, this may concern a shopkeeper who looks for consignments that carry good prices, although more highly developed forms are known. Specialised agents within different product fields, for instance in air travel, is one example in this regard. The customer reports his/her requirements, which should be flexible in some form in order to have the best effect. The agent then takes the travel requirement and presents it to a number of different airlines and the best airline is offered to the customer. This process is normally referred to as a reverse option. U.S. Pat. Nos. 5,897,620 and 5,794,207 are examples of patent publications that describe this process.

Another form that has been brought to the attention of the general public is co-operative buying, where a tradesman collects potential customers who are interested in one and the same product so as to induce the manufacturer to offer attractive prices due to the large number of customers involved. The main problem in this respect is that the purchase takes a long time to come into fruition, since the customer must first report his/her interest and the tradesman, who does not known the supplier in many cases and quite likely lacks expertise in the product area concerned, must then obtain the products. Another problem with co-operative buying of this kind is that manufacturers are reluctant to accept distributors that solely have low prices as a sales argument and little or no knowledge of the product.

It will be understood that by unit and object is meant in this description both goods and services. Thus, the present invention enables payment to be made for both products and/or services.

Technical Problems

When considering the present standpoint of techniques as described above, it will be seen that with a starting point from a method for secure transfer of payment in connection with network commerce, where a consumer contacts a supplier for the purchase of a unit, and where this contact has been made via a first message, a technical problem exists in the ability of offering a payment option in which the consumer knows that he only pays for the purchase and where this payment can be brought about quickly and in a manner that is safe with respect to both the consumer and the supplier.

Another technical problem is one of offering the consumer the option of using an established contact with a payment institution for payment of a unit purchased from any chosen supplier, whereby the consumer can feel safe in the confidence felt with respect to established payment institutions.

Another technical problem is one of offering the consumer the possibility of identifying himself/herself to the payment institutions through the medium of an identification process established with the payment institutions, whereafter the consumer can allow the payment institutions to pay the supplier for the purchased product.

Another technical problem is one of persuading a number of different suppliers to accept payment from a number of different payment institutions, in a simple manner.

Another technical problem is one of offering payment transfers via a network in respect of different purchasing situations, such as in the case of purely network commerce, in respect of post order purchases, in respect of purchases made by telephone contacts, in respect of direct counter purchases, or in respect of purchases made via interactive television

Another technical problem is one of offering the consumer the option of carrying out the established identification process in different ways in the aforesaid different purchasing situations.

Another technical problem is one of offering the option of the use of different types of payment institutions in respect of the payment transfer, and not solely traditional payment institutions, such as banks.

Another technical problem is one of offering a customer the option of using reverse auction. In conjunction with this, a technical problem also resides in shortening the waiting time on the part of the customer, in other words the time that the customer must wait before receiving an offer from a supplier.

In the case of reverse auction, a technical problem resides in providing the customer with information in a way that is competitively neutral, so that parties involved can act in a manner which has already been established between the parties and so that the customer can reach a decision independently.

Solution

With the intention of solving one or more of the aforesaid technical problems, the present invention takes as its starting point a method for secure transfer of payment via a network in conjunction with commercial transactions, where a consumer is in contact with a supplier for the purchase of a unit, and where said contact is made via a first message.

The present invention is based on the giro model, where the consumer takes the initiative of transferring to the supplier money corresponding to the purchase price.

In this regard, the present invention proposes that the confidence that exists mutually between the consumer and a payment institutions used by the consumer is utilised as a part of a payment solution.

The functions demanded by buyer and seller should conveniently be offered to the parties by a free-standing organisation that is independent of the parties concerned. Such an organisation may be in contact with the consumers and with the suppliers, although respective consumers and suppliers need only one contact.

With the intention of providing a method which enables payment to be transferred from a consumer to a supplier in a manner satisfactory to both parties, it is proposed in accordance with the present invention that the consumer shall have an established process of identification with some kind of payment institution.

According to the present invention, an independent party shall pass from the supplier to the payment institution a query concerning the possibility of obtaining payment in connection with said purchase.

The consumer approves payment for the purchase in accordance with the established process of identification, whereafter the payment institution pays the supplier for the purchase in accordance with the approval, either directly or indirectly.

According to the invention, this is effected by the consumer informing the supplier that payment for the purchase shall be undertaken via the independent party. This is done in conjunction with the first message. In a second message, the independent party is asked by the supplier whether payment for the purchase can be transferred from the customer. The independent party sends the query to the payment institution in a third message. The payment institution requests from the consumer confirmation that payment for the purchase shall be made to the supplier, in a fourth message. In a fifth message, the consumer confirms to the payment institution that payment for the purchase shall be made. Subsequent to this confirmation, the payment institution sends said confirmation to the independent party, in a sixth message. The independent party sends the confirmation to the supplier in a seventh message, whereafter the supplier delivers the unit to the consumer subsequent to receiving said confirmation.

The fourth and fifth messages include a procedure that follows the established process of identification, which, in turn, includes positive identification of the consumer by the payment institution.

A number of different types of networks are used for implementing the present invention, and the second to the seventh messages, inclusive, can thus be sent via a network, such as the global network Internet, an Intranet or a network for cable television.

In order to enable payments to be transferred, or mediated, in this way in respect of purchases made with a number of different suppliers and via a number of different payment institutions, it is proposed in accordance with the present invention that the independent party has an established relationship with a number of different suppliers and a number of different payment institutions.

It will be understood that there is nothing to prevent a payment institution or a supplier from taking the role of the independent party.

With the intention of enabling payment to be mediated in accordance with the above in a number of different purchasing situations, it is proposed in accordance with the invention that the first message is sent via a network, such as the global network Internet, via the mail, such as in post order purchases, via interactive television, such as cable television, or is made by direct communication between the consumer and the supplier, such as in the case of a counter purchase at the supplier or in a telephone contact.

The present invention also proposes that the consumer can have an established process of identification with a payment institution that enables the identification process to be carried out in one of several different ways, such as via a computer unit, via interactive television, such as cable television, or via a portable unit, such as a portable computer or a portable telephone.

According to the present invention, the payment institution concerned may be a loan institution, such as a bank, in which the consumer has funds deposited and/or a credit from which money can be taken for payment. The payment institution may also consist of a manufacturer, trading company and/or service intermediary, such as a post order company, a teleoperator, or a cable television operator.

In these latter cases, it is possible to allow the money required to make the payment to be billed to the consumer, such as billing for goods or services that the consumer normally purchases from the payment institution.

It is proposed in accordance with the invention that at least the second, third and fourth messages will include the information necessary to identify the unit, consumer, supplier concerned, and the amount to be paid, so that the consumer will have the information required to be able to confirm that payment shall be made.

According to the present invention, it is possible to allow the independent party to store information in a database concerning what has been soled, the identity of the seller, and the cost involved by the sale, so as to offer further services. It is also possible to allow the stored information to include the time at which the sale took place and the identity of the buyer, in respect of respective purchases.

According to the present invention, such an additional service may involve a potential buyer who is interested in purchasing an object and who reports to the independent party of the nature of the object he/she wishes to buy. The independent party then makes an inquiry at suppliers of the object in question, in accordance with the database. This inquiry includes information relating to price and other delivery conditions in respect of relevant objects according to stored information.

When the inquiry includes information relating to the customer, it is proposed in accordance with the present invention that the suppliers that are interested offer the customer the opportunity to purchase the object, whereafter the customer can effect a purchase of the object in accordance with one of the offers.

In other cases, it is proposed in accordance with the invention that suppliers inform the independent party of the relevant conditions of their offers, that the independent party compiles the information received on behalf of the customer, and that the independent party sends the information to the customer, whereafter the customer is able to purchase the object in accordance with one of the offers.

When a prospective customer wishes to purchase an object, it is proposed in accordance with the present invention that the further service may consist in the customer informing the independent party of the object(s) that he/she wishes to purchase. The independent party then utilises information that has been created by earlier purchases that have been made and stored in the database, wherein the independent party produces from this information fresh information for guidance of the customer in the present purchasing situation.

In all of the above examples of the inventive reverse auctions, the customer is completely free from the independent party subsequent to the information having been received, and the customer is thus able to deal with desired suppliers in an independent and selective manner. Naturally, this commercial transaction can be carried into effect in accordance with what has been described above, although it is also possible to choose to effect a commercial transaction in some other way.

The demand for a common payment solution is the same with both consumer and supplier. None of them will, or be able to, connect the system to all parties in the second group. The parties desire uniform solutions that are offered in accordance with the solution described above.

These solutions are conveniently manifested in computer program products that is installed together with the own systems. Such program products can then be distributed to customers on data media or via a data network. The requisite computer program product essentially concerns communication between different suppliers and the independent party, and between different payment institutions and said independent party.

It should be possible for communication between consumer/customer and other parties to be implemented through the medium of existing means. The consumer shall communicate with the payment institution concerned in a manner that has already been established between the consumer and said institution. Communication of the consumer with the supplier is effected by different means, depending how the contact is made. The main transmission of information that is specific to the present invention takes place when the independent party is involved.

Thus, the present invention also proposes a first computer program product which includes a computer program code which, when executed by a computer accessible to a supplier, functions to put into effect the steps concerning communication of the supplier with an independent party, in accordance with the inventive method as described above.

The present invention also proposes a second computer program product which includes a computer program code that when executed by computer available to an independent party functions to put into effect the steps that concern communication of an independent party with a supplier, and communication of an independent party with a payment institution in accordance with the inventive method as described above.

The present invention also proposes a third computer program product which includes a computer program code that when executed by a computer accessible to a payment institution functions to put into effect the steps that concern communication with the payment institution with an independent party in accordance with the inventive method as described above.

The present invention also proposes a carrier medium which carries computer program codes in accordance with one or more of said computer program products, and a computer readable medium in which computer program codes according to one or more of said computer program products are stored.

Advantages

Those advantages that are primarily characteristic of the present invention reside in providing a consumer with the possibility of purchasing a unit or service via a network, interactive television, post order, telephone, or directly over the counter, and to pay through the medium of a payment institution where the consumer himself confirms the billing in a manner established for the consumer, without the supplier being able to obtain more payment than that confirmed by the consumer and with an assurance from the payment institution that the supplier will be paid.

The present invention also enables a customer to be able to trade in a number of different ways by so-called reverse auction while using the inventive safe payment transfer.

The primary characteristic features of an inventive method are set forth in the characterising clause of the accompanying claim 1. The characteristic features of different computer program products according to the present invention are set forth in the characterising clause of the accompanying claims 23, 24 and 25. The primary characteristic features of an inventive carrier medium are set forth in the characterising clause of the accompanying claim 26. The primary characteristic features of a computer readable medium according to the present invention are set forth in the characterising clause of the accompanying claim 27.

### BRIEF DESCRIPTION OF THE DRAWINGS

A method, computer program product, a carrier medium, and a computer readable medium according to the invention will now be described in more detail by way of example and with reference to the accompanying drawings, in which

FIG. 1 is a highly simplified and schematic illustration of a relationship between a consumer, a supplier, a payment institution, and an independent party;

FIG. 2 is a schematic illustration of a purchase effected via a cable television network in accordance with the present invention;

FIG. 3 illustrates schematically a purchase made directly over a counter in accordance with the present invention;

FIG. 4 illustrates a first embodiment of the manner in which the independent party uses a database to provide an additional service for a customer;

FIG. 5 illustrates a second embodiment of how the independent party uses a database to offer a further service to a customer; and

FIG. 6 illustrates schematically how computer program product products that enable an inventive method to be carried out can be distributed between an independent party, a supplier and a payment institution.

### DESCRIPTION OF EMBODIMENTS AT PRESENT PREFERRED

The present invention relates to a method for safe mediation of payment via a network in connection with commercial transactions in which a consumer 1 is in contact with a supplier 2 for the purchase of a unit 2a.

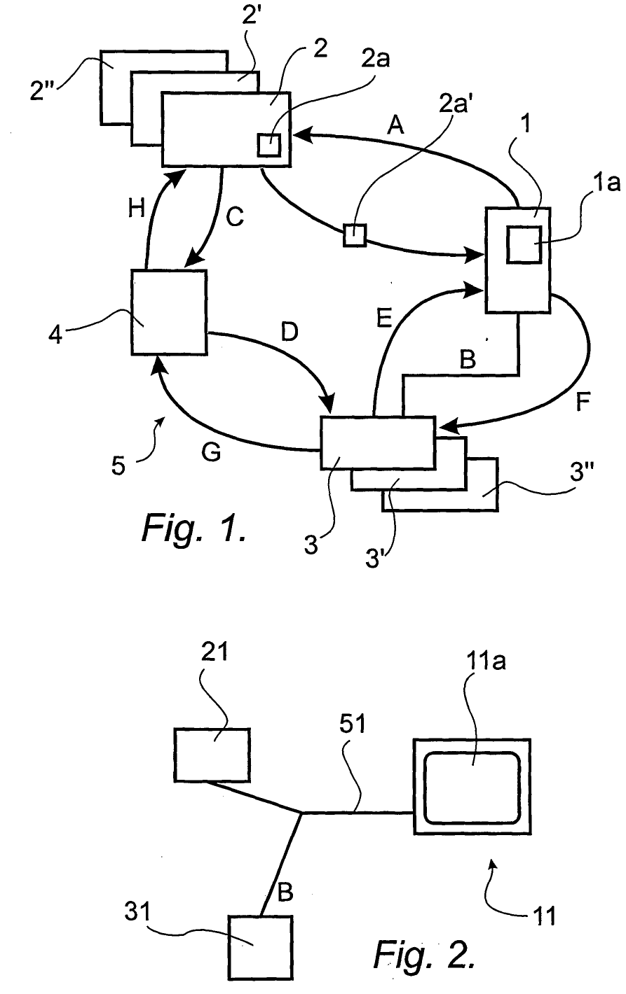

FIG. 1 shows that contact has been established between a consumer 1 and a supplier 2 via a first message A. The present invention is based on the consumer 1 having an established process of identification B with a payment institution 3 of some kind. The consumer 1 feels secure in this established identification process B and the present invention allows the consumer 1 to transfer payment to the supplier 2, through the medium of this established contact B.

When a consumer 1 says that he/she will pay in accordance with a method according to the present invention, the supplier 2 asks a question C of an independent party 4, which transfers D the request to the payment institution 3 given by the consumer 1.

This question C, D concerns the possibility of obtaining payment in connection with the purchase.

After the payment institution 3 has received the query D, the consumer can confirm payment for the purchase in accordance with the established identification process B.

The payment institution 3 then pays the supplier 2 for the purchase, either directly or indirectly, in accordance with the endorsement given by the consumer 1. The present invention is not involved in how this payment is made, and consequently it will not be described in further detail in this document. Payment may be effected by a direct transfer or by a later payment. It is, however, probable that the supplier will be willing to grant credit to the payment institution and that the payment institution is willing to effect payment in accordance with the approval of the buyer, as a result of the established contact with the buyer.

According to the invention, the method can be carried out in accordance with the following steps:

The consumer 1 informs the supplier 2 that payment for the purchase through the unbiased mediation of the independent party 4.

in a second message C the supplier 2 asks a question of the independent party 4 regarding the possibility of obtaining mediation of payment for the purchase from the customer 1;

the independent party 4 forwards the query to the payment institution 3, in a third message D;

the payment institution 3 requests from the consumer 1 confirmation that payment for the purchase shall be made to the supplier 2, in a fourth message E;

the consumer 1 confirms to the payment institution 3 that payment for the purchase shall be made, in a fifth message F;

subsequent to receiving this confirmation, the payment institution 3 sends said confirmation to the independent party 4, in a sixth message G;

the independent party 4 sends the confirmation to the supplier 2 in a sixth message H;

whereafter, subsequent to receiving the confirmation H, the supplier 2 delivers the unit 2a′ to the consumer 1.

The fourth and fifth messages E, F include a procedure according to the established identification process B, which includes, per se, positive identification of the consumer 1 by the payment institution 3.

According to a preferred embodiment of the present invention, the second to seventh messages C, D, E, F, G, H are sent via a network 5, such as the global network Internet, an Intranet, or a cable television network.

With the intention of offering a wide choice of suppliers and payment institutions that can handle payments in accordance with the present invention, it is proposed in accordance with the invention that said independent party 4 has an established relationship with a number of different suppliers 2, 2′, 2″ and a number of different payment institutions 3, 3′, 3″.

It will be understood that there is nothing to prevent one of the payment institutions 3, 3′, 3″ or one of the suppliers 2, 2′, 2″ from taking the role of said independent party 4. For instance, it may be so that a bank offers the service that the independent party possesses, and that the same bank also offers its clients the service that a payment institution possesses in accordance with the present invention.

According to the present invention, the direct contact between the consumer and the supplier, i.e. the first message A, is taken in many different ways. This message may, for instance, be sent via a network, such as the global network Internet, by post, such as in the case of post order purchases, via interactive television, such as cable television, or may be made by direct communication between the consumer and the supplier, for instance when purchasing over the counter of the supplier, or by telephone. FIG. 1 shows schematically the first message A being sent by means of the global network Internet 5.

The present invention can thus be applied in connection with any purchasing situation whatsoever, where the consumer is not able to pay cash or wishes to pay cash, or wishes to pay by credit card, for instance.

These different purchasing situations, however, require the consumer 1 to communicate with the payment institution 3 in some way or another, to confirm that payment shall take place F. This can be carried out in different ways in accordance with the invention.

The established process of identification can be carried out via a computer unit 11, such as when the consumer effects an e-commerce purchase via the computer unit, for instance through a home computer.

FIG. 2 is intended to show that it is also possible to allow the consumer 11 to carry out the established process of identification B via interactive television 11a, such as cable television. This figure illustrates schematically how the television apparatus 11a of the consumer 11 is connected to a television cable network 51, through which contact is obtained with the supplier 21 and the payment institution 31. The figure illustrates the particular case in which the entire purchase is effected via interactive television.

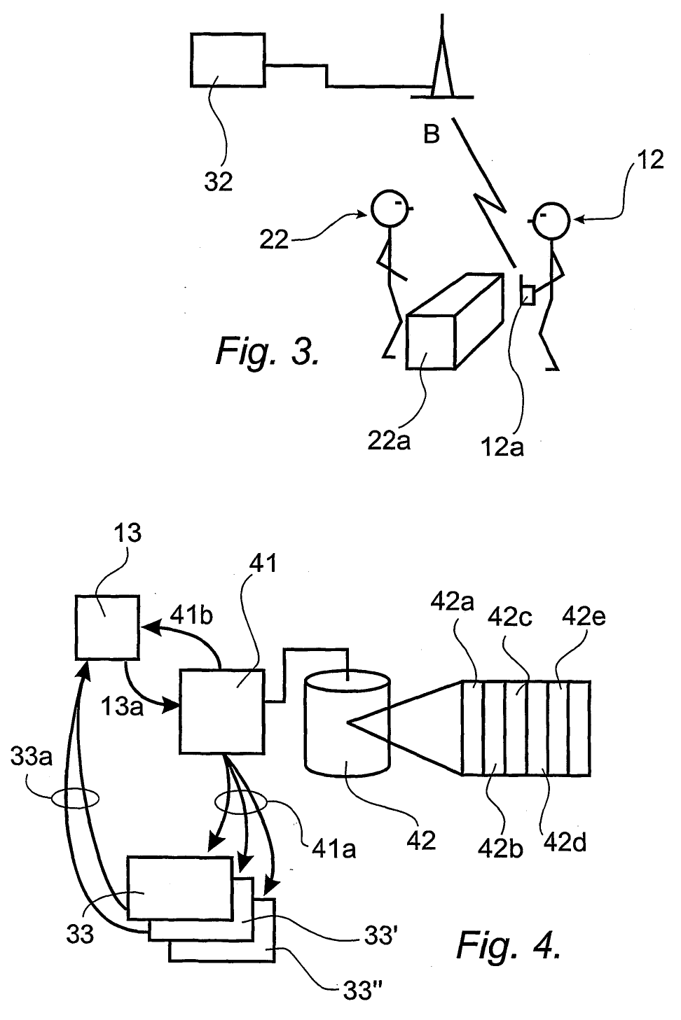

FIG. 3 is intended to illustrate that the consumer 12 can also be conceived to carry out the established identification process B via a portable unit 12a, such as a portable computer or a portable telephone. This embodiment is particularly advantageous when the consumer 12 is in direct contact with the supplier 22, over the counter 22a.

It will be understood that these figures solely illustrate examples of embodiments and that there is nothing to prevent the use of different communications devices in respect of the contact between consumer and supplier and in respect of the contact between consumer and payment institution. For instance, contact between consumer and supplier may take place through interactive television, via a cable television network, whereas contact between consumer and payment institution may take place over the global network Internet via a home computer in one and the same purchasing situation.

Referring to FIG. 1, it will be seen that the payment institution 3, 3′, 3″ is comprised of different institutions. According to a preferred embodiment, the payment institution 3 is a lending institution, such as a bank, in which the consumer has funds on deposit and/or a credit agreement from which funds can be taken for payment of the purchased unit.

In another conceivable embodiment, the payment institution is comprised of a manufacturer, a goods intermediary and/or service intermediary 3′, such as a post order company, a telephone operator or a cable television operator, with whom the consumer 1 has an established relationship 3′.

In this case, it is possible for the consumer 1 to be billed the sum required to effect payment, in the same way as billing is made for goods or services purchased by the consumer 1 from the payment institution 3′. This can be done separately for the specific purchase or in conjunction with the billing of other goods or services that the consumer 1 purchases from the payment institution 3′.

With the intention of offering desired security to the supplier 2, the payment institution 3, and the consumer 1, it is proposed in accordance with the invention that at least the second, third and fourth messages C, D, E include information necessary in identifying the relevant unit 2a, the consumer 1, and the amount to be paid.

As illustrated in FIG. 4, because the independent party 41 handles a substantial amount of information concerning units to be sold and at which price, it is an easy matter for the independent party 41 to store information in a database 42 with respect to what is sold 42a, who the seller is 42b, and the price of the sale taking place 42c, so as to provide further services, in accordance with the invention.

The stored information 42 may also include the time at which the sale 42d took place and who the purchaser 42e was on any particular occasion.

In the case of such a database 42, the additional service may assist a customer 13 endeavouring to purchase an object, by informing 13a the independent party 41 of the customer's interest in purchasing said object. The independent party 41 can then send an inquiry 41a of the supplier 33, 33′, 33″ regarding said object, on the basis of the information 42b stored in the database 42. This inquiry 41a may, for instance, concern the availability and the price of the object concerned.

This inquiry will preferably include information concerning price 42c and other conditions for delivery of the object stored in the database 42.

Such an inquiry directed to concerned suppliers 33, 33′, 33″ may also include information relating to the customer 13 in question. After receiving this inquiry, the supplier 33, 33′ that are willing offer, 33a, the customer 13 the chance to purchase the object in question, whereafter the customer 13 can effect purchase of said object in accordance with one of these offers 33a.

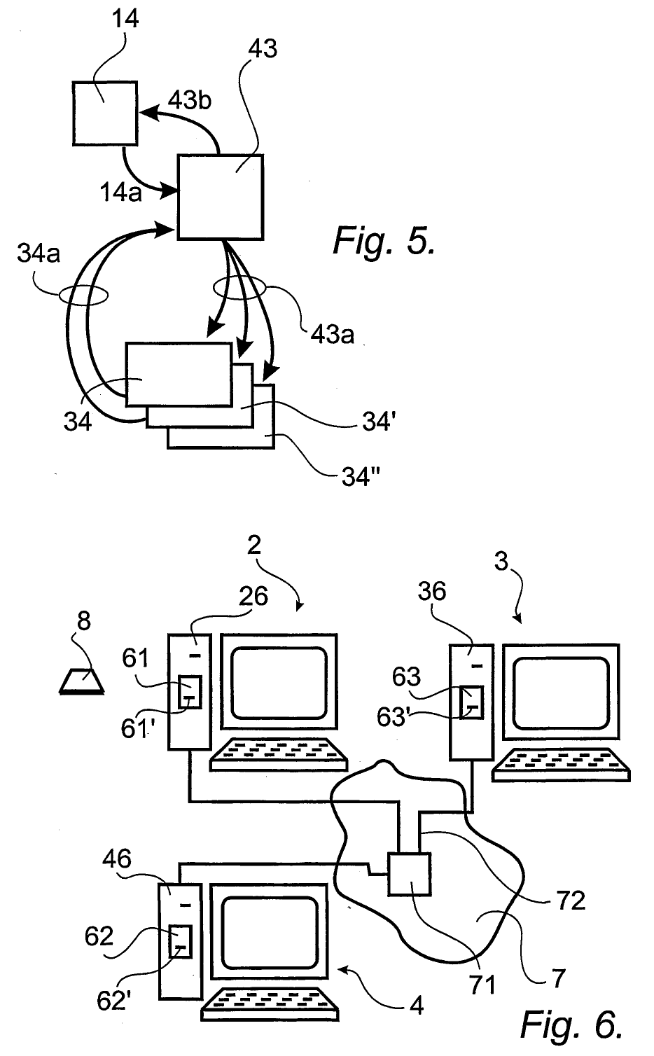

FIG. 5 illustrates an example in which a customer 14 is unwilling to give personal information to the various suppliers 34, 34′, 34″. When the customer 14 informs, 14a, the independent party 43 of the interest in an object, the independent party sends an inquiry 43a to those suppliers that can be believed to be able to supply this object. According to this embodiment, respective suppliers 34, 34′ are able to inform, 34a, the independent party 43 of the relevant conditions for their offers. The independent party 43 can then compile the information 34a obtained on behalf of the customer 14, and send, 43b, said information to the customer, whereafter the customer 14 can purchase the object in accordance with one of the offers 34a.

FIG. 4 also shows that the present invention enables a quick response 41b to be made to an inquiring customer 13, by allowing the additional service to consist in the customer informing, 13a, the independent party 41 that an object is desired for purchase, when a customer 13 seeks to purchase said object.

According to this embodiment, it is proposed that the independent party 41 utilises the information 42a, 42b, 42c, 42d, 42e that has been created through the medium of purchases that have already been made and stored in the database 42, whereafter the independent party 41 produces from this information 42a, 42b, 42c, 42d, 42e fresh information 41b for the guidance of the customer 13 in its purchasing situation.

In this way, it is unnecessary for the independent party 41 to ask questions of different suppliers 33, 33′, 33″ and wait for an answer, as only the information available in the database 42 is used to meet the information requirements of the customer 13, therewith enabling a quick reply to be made back to the customer.

It is in connection with this embodiment that time information 42d, may be useful, i.e. information relating to the time of purchase, since the reliability of available information, and therewith its use to the customer 13, is tied to the age of the information.

FIG. 6 is intended to illustrate that the present invention provides a possibility of readily distributing those functions required of traders and a payment institution respectively. Thus, the present invention also relates to a first computer program product 61 which includes a computer program code 61′ which, when executed by a computer 26 available to a supplier 2, functions to put into effect the steps that concern communication of a supplier 2 with an independent party, in accordance with the aforegoing.

The present invention also relates to a second computer program product 62 which includes a computer program code 62′ which, when executed via computer 46 that is available to an independent party 4, functions to put into effect the steps that concern communication of an independent party 4 with a supplier 2, and communication of an independent party 4 with a payment institution 3, in accordance with the aforegoing.

The present invention also relates to a third computer program product 63 which includes a computer program code 63′ which, when executed by a computer 36 that is available to a payment institution 3, functions to put into effect those steps concerning communication of a payment institution 3 with an independent party 4, in accordance with the aforegoing.

The present invention also relates to a carrier medium 7 which carries a computer program code 61′, 62′, 63′ according to one or more of the first, second and third computer program products 61, 62, 63. This carrier medium 7 may, for instance, be a network with those units 71, 72 that are required to carry information within said network, such as the global network Internet, a cable television network, or an Intranet.

The present invention also relates to a computer readable medium 8 on which computer program codes 61′, 62′, 63′ according to one or more of the first, second and third computer program products 61, 62, 63 are stored, such as a compact disk (CD), a digital versatile disk (DVD), a diskette or a tape.

It will be understood that the present invention is not restricted to the aforedescribed exemplifying embodiments thereof and that modifications can be made within the scope of the inventive concept as illustrated in the accompanying claims.

1. A method of mediation of payment via a network in connection with commercial transactions in which a consumer is in contact with a supplier for the purchase of a unit, where said contact is made via a first message, characterized in that said consumer has an established process of identification with a payment institution; in that an independent party acts as an intermediary or middleman, in response to an inquiry from said supplier to said payment institution concerning the possibility of obtaining payment in connection with said purchase; in that said consumer confirms payment for said purchase in accordance with said established identification process; and in that said payment institution pays said supplier for said purpose in accordance with said confirmation, either directly or indirectly.

2. A method according to claim 1, characterized in that said consumer informs the supplier in said first message that payment for the purchase shall be mediated via said independent party; in that said supplier sends in a second message to said independent party an inquiry concerning the possibility of obtaining mediation of payment for said purchase from said customer; in that said independent party forwards said inquiry to said payment institution in a third message; in that said payment institution asks said consumer to confirm that payment for said purchase shall be made to said supplier, in a fourth message; in that said consumer sends in a fifth message confirmation to the effect that payment shall be made for said purchase; in that after having received said confirmation the payment institution sends said confirmation to said independent party, in a sixth message; in that said independent party sends said confirmation to said supplier in a seventh message, whereafter said supplier delivers said unit to the consumer after having received said confirmation; and in that said fourth and fifth messages include a procedure according to said established identification process which includes identification of said consumer by said payment institution.

3. A method according to claim 2, characteriz d in that said second to seventh message inclusive are sent via a network, such as the global network Internet, an Intranet or a cable television network.

4. A method according to claim 1, 2 or 3, characteriz d in that said independent party has an established relationship with a number of different suppliers and with a number of different payment institutions.

5. A method according to claim 4, characterized in that one of said payment institutions or one of said suppliers takes the role of an independent party.

6. A method according to any one of the preceding claims, characterized in that said first message is sent via a network, such as the global network Internet.

7. A method according to any one of claims 1 to 5, characterized in that said first message is sent by post, such as in the case of post order buying.

8. A method according to claims 1 to 5, characterized in that said first message is sent via interactive television, such as cable television.

9. A method according to claims 1 to 5, characterized in that said first message consists of a direct communication between the consumer and the supplier, such as when buying across the counter of said supplier, or through telephone contact.

10. A method according to claim 6, 7, 8 or 9, characterized in that said consumer carries out said established identification process via a computer unit.

11. A method according to claim 6, 7, 8 or 9, characterized in that the consumer carries out said established identification process via interactive television, such as cable television.

12. A method according to claim 6, 7, 8 or 9, characterized in that the consumer carries out said established identification process via a portable unit, such as a portable computer or a portable telephone.

13. A method according to any one of the preceding claims, characterized in that said payment institution consists of a lending institution, such as a bank, in which the consumer has money deposited and/or a credit allowance from which said payment can be taken.

14. A method according to any one of claims 1 to 12, characterized in that said payment institution consists of a manufacturer, a goods mediator, or middleman, and/or a service mediator, or middleman, such as a post order company, a telephone operator or a cable television operator.

15. A method according to claim 14, characterized in that the money required for payment is billed to the consumer in the same way as billing is made for goods or services that said consumer purchases from said payment institution.

16. A method according to any one of the preceding claims, characterized in that at least said second, third and fourth messages include information necessary for identifying said unit, said consumer, said supplier, and also the amount to be paid.

17. A method according to claim 16, characterized in that said independent party stores in a database information relating to what has been sold, the identity of the seller, and the price of the sale, so that additional services can be offered.

18. A method according to claim 17, characterized in that the information stored may include the time at which the sale took place.

19. A method according to claim 16 or 17, characterized in that the information stored may include the identity of the buyer in respective purchases.

20. A method according to claim 17, 18 or 19, characterized in that said additional services consist in the wish of a customer to purchase an object, in the customer informing said independent party of his/her interest in purchasing said object, in the independent party making inquiries to suppliers of said object in accordance with information stored in said database; and in that said inquiry includes information concerning price and other conditions for delivery of said object in accordance with said stored information.

21. A method according to claim 20, characterized in that said inquiry includes information relating to the customer; and in that those suppliers who are willing to sell offer the customer the chance to purchase said object, whereafter said customer can purchase said object in accordance with one of said offers.

22. A method according to claim 20, characterized in that said suppliers inform the independent party of the conditions on which their offers are based; in that said independent party compiles the information obtained on behalf of the customer; in that the independent party sends said information to the customer, whereafter said customer can purchase said object in accordance with one of said offers.

23. A method according to claim 17, 18 or 19, characterized in that said additional service consists in a customer seeking to purchase an object; in that the customer informs the independent party of the object desired for purchase; in that the independent party utilises the information that has been gathered as a result of previous purchases and stored in said database, and produces fresh information on the basis of the stored information for guidance of the customer in his/her purchasing situation.

24. A first computer program product, characterized in that said first computer program product includes a computer program code which, when executed by a computer that is available to a supplier, functions to put into effect the steps that concern the communication of said supplier with an independent party in accordance with the method of one of claims 1 to 23.

25. A second computer program product, characterized in that said second computer program product includes a computer program code which, when executed by a computer that is available to an independent party, functions to put into effect the steps that concern the communication of said independent party with a supplier and the communication of said independent party with a payment institution in accordance with any one of claims 1 to 23.

26. A third computer program product, characterized in that said third computer program product includes a computer program code which, when executed by a computer that is available to a payment institution, functions to put into effect the steps that concern communication of the payment institution with an independent party in accordance with a method in any one of claims 1 to 23.

27. A carrier medium, characterized in that said medium carries a computer program code according to one or more of claims 24 to 26.

28. A computer readable medium, characterized in that said computer program code according to one or more of claims 24 to 26 is stored in the computer readable medium.
